(19) United States
(12) Patent Application Publication
(10) Pub. No.: US 2024/0128802 A1
(43) Pub. Date: Apr. 18, 2024

(54) WIRELESS CHARGER

(71) Applicant: Lanto Electronic Limited, Kunshan City (CN)

(72) Inventor: CaiYu DU, Kunshan City (CN)

(73) Assignee: Lanto Electronic Limited, Kunshan City (CN)

(21) Appl. No.: 18/074,904

(22) Filed: Dec. 5, 2022

(30) Foreign Application Priority Data
Oct. 12, 2022 (CN) 202211246787.0

(51) Int. Cl. H02J 50/70; H02J 50/00; H02J 50/10; H02J 50/90

(52) U.S. Cl. CPC H02J 50/70; H02J 50/005; H02J 50/10; H02J 50/90

(57) ABSTRACT

The present disclosure discloses a wireless charger comprising a housing, a wireless charging assembly and a positioning magnet assembly. The wireless charging assembly is arranged in the housing. The positioning magnet assembly is arranged around the wireless charging assembly. The spacer assembly is arranged between the wireless charging assembly and the magnet positioning assembly. The present disclosure provides a wireless charger in which the spacer assembly separates the wireless charging assembly and the positioning magnet assembly so as to reduce the influence of the positioning magnet assembly on the wireless charger.

### CROSS-REFERENCE TO RELATED APPLICATION

This application claims the priority benefit of Chinese Patent Application Serial Number 202211246787.0, filed on Oct. 12, 2022, the full disclosure of which is incorporated herein by reference.

### BACKGROUND

### Technical Field

The present disclosure relates to the technical field of wireless charging, particularly to a wireless charger.

### Related Art

Regarding the current charging technology for mobile phones, in addition to the general charge using wire, most of them are now charged by wireless charging, thus eliminating the need to carry wires. Wireless charging is through the charging coil in the charging device corresponding to the receiving coil close to the electronic device, so that the charging method can be achieved without the actual contact connection through the wire. However, in the above-mentioned wireless charging method, the receiving coil of the electronic device and the charging coil in the charging device need to be matched with each other to achieve a good charging effect. The existing match methods include positioning by groove fitting or by magnetic attraction. The groove fitting manner would have limitation arisen from the size of the electronic device, which is rather inconvenient to use. In addition, the magnetic attraction manner would have the charging efficiency problem of the charging coil because the magnet is located around the coil.

### SUMMARY

The embodiments of the present disclosure provide a wireless charger, which can solve the problem of the influence of magnets on the wireless charging arisen from using the magnetic attraction manner.

The present disclosure provides a wireless charger comprising a housing, a wireless charging assembly and a positioning magnet assembly. The wireless charging assembly is arranged in the housing. The positioning magnet assembly is arranged around the wireless charging assembly. The spacer assembly is arranged between the wireless charging assembly and the magnet positioning assembly.

In one embodiment, the spacer assembly comprises a side plate and a bottom plate; the bottom plate is disposed at the bottom of the positioning magnet assembly; the side plate is disposed at one side of the bottom plate close to the wireless charging assembly.

In one embodiment, the height of the side plate is equal to or higher than one third of the height of the side surface of the positioning magnet assembly adjacent to the wireless charging assembly.

In one embodiment, the spacer assembly comprises a side plate and a bottom plate; the bottom plate is disposed on the bottom of the wireless charging assembly, and the side plate is disposed on a side of the bottom plate close to the positioning magnet assembly.

In one embodiment, the height of the side plate is equal to or higher than one third of the height of the side surface of the wireless charging assembly adjacent to the positioning magnet assembly.

In one embodiment, the spacer assembly comprises a first spacer and a second spacer; the first spacer and the second spacer are located between the wireless charging assembly and the positioning magnet assembly; the first spacer is disposed in the positioning magnet assembly; the second spacer is disposed in the wireless charging assembly.

In one embodiment, the first spacer comprises a first side plate and a first bottom plate; the first bottom plate is disposed at the bottom of the positioning magnet assembly; the first side plate is disposed at one side of the first bottom plate close to the wireless charging assembly; the second spacer comprises a second side plate and a second bottom plate; the second bottom plate is disposed at the bottom of the wireless charging assembly; the second side plate is disposed at one side of the second bottom plate close to the positioning magnet assembly.

In one embodiment, the material of the spacer assembly is iron.

In one embodiment, the positioning magnet assembly comprises a first positioning magnet and a second positioning magnet; the second positioning magnet is located at one side of the first positioning magnet; the first positioning magnet is adjacent to the wireless charging assembly; and the first positioning magnet is adjacent to the wireless charging assembly; the second positioning magnet is away from the wireless charging assembly; the first positioning magnet and the second positioning magnet are fixed by glue.

In one embodiment, two sides of the first positioning magnet respectively comprise a first magnetic pole and a second magnetic pole; the first magnetic pole faces the surface of the housing; the second magnetic pole faces the interior of the housing; two sides of the second positioning magnet respectively comprise a third magnetic pole and a fourth magnetic pole; the third magnetic pole faces the surface of the housing; the fourth magnetic pole faces the interior of the housing.

In one embodiment, the magnetic pole of the first magnetic pole and the magnetic pole of the second magnetic pole is different; the magnetic pole of the third magnetic pole and the magnetic pole of the fourth magnetic pole is different; the magnetic pole of the first magnetic pole and the magnetic pole of the fourth magnetic pole is the same; the magnetic pole of the second magnetic pole and the magnetic pole of the third magnetic pole is the same.

In one embodiment, there are multiple positioning magnet assemblies, and the multiple positioning magnet assemblies are arranged around the wireless charging assembly.

In one embodiment, the wireless charging assembly comprises a transmitting coil and a magnetically conductive carrier plate; the transmitting coil is arranged on the magnetically conductive carrier plate; the transmitting coil corresponds to the surface of the housing.

In one embodiment, the wireless charging assembly and the positioning magnet assembly correspond to the surface of the housing for placing the electronic device for charging; the electronic device comprises a device receiving coil and a device positioning magnet; the device positioning magnet is located around the device receiving coil; the device receiving coil corresponds to the transmitting coil of the wireless charging assembly; the device positioning magnet corresponds to the positioning magnet assembly.

In one embodiment, the housing comprises a case and a cover plate; the case comprises an accommodating slot; the cover plate covers the notch of the accommodating slot, the wireless charging assembly; the wireless charging assembly, the positioning magnet assembly and the spacer assembly are arranged in the accommodating slot; the wireless charging assembly is arranged at the position of the cover plate correspondingly; the positioning magnet assembly is arranged around the notch of the accommodating slot.

The disclosure provides a wireless charge, in which the wireless charging assembly and the positioning magnet assembly are separated by the spacer assembly. The spacer assembly can effectively reduce the magnetic force of the positioning magnet assembly to escape toward the magnetically conductive carrier plate of the wireless charging assembly. In this way, the magnetic field interference of the positioning magnet assembly on the wireless charging assembly can be effectively avoided, so as to provide a good charging effect.

It should be understood, however, that this summary may not contain all aspects and embodiments of the present disclosure, that this summary is not meant to be limiting or restrictive in any manner, and that the disclosure as disclosed herein will be understood by one of ordinary skill in the art to encompass obvious improvements and modifications thereto.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 is a perspective view of a wireless charger of the present disclosure;

FIG. 2 is the sectional view alsing A-A′ line of FIG. 1;

FIG. 3 is an exploded view of the wireless charger of the present disclosure;

FIG. 4 is an enlarged view of the B region of the first embodiment of FIG. 2;

FIG. 5 is an enlarged view of the second embodiment;

FIG. 6 is an enlarged view of the third embodiment; and

FIG. 7 is an enlarged view of the fourth embodiment.

### DETAILED DESCRIPTION OF THE EMBODIMENTS

The present disclosure will now be described more fully hereinafter with reference to the accompanying drawings, in which exemplary embodiments of the disclosure are shown. This present disclosure may, however, be embodied in many different forms and should not be construed as limited to the embodiments set forth herein. Rather, these embodiments are provided so that this present disclosure will be thorough and complete, and will fully convey the scope of the present disclosure to those skilled in the art.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substantial/substantially” means, within an acceptable error range, the person skilled in the art may solve the technical problem in a certain error range to achieve the basic technical effect.

The following description is of the best-contemplated mode of carrying out the disclosure. This description is made for the purpose of illustration of the general principles of the disclosure and should not be taken in a limiting sense. The scope of the disclosure is best determined by reference to the appended claims.

Moreover, the terms “include”, “contain”, and any variation thereof are intended to cover a non-exclusive inclusion. Therefore, a process, method, object, or device that includes a series of elements not only includes these elements, but also includes other elements not specified expressly, or may include inherent elements of the process, method, object, or device. If no more limitations are made, an element limited by “include a/an” does not exclude other same elements existing in the process, the method, the article, or the device which includes the element.

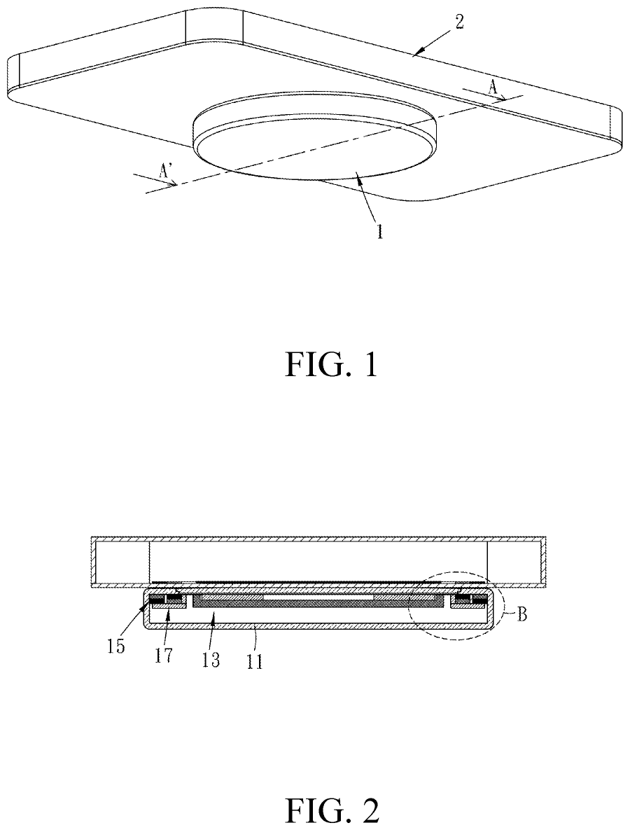

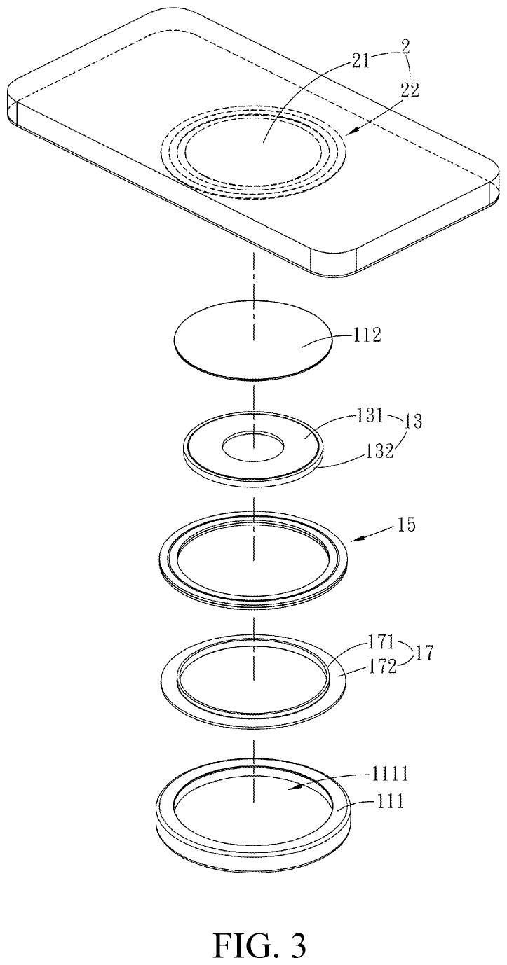

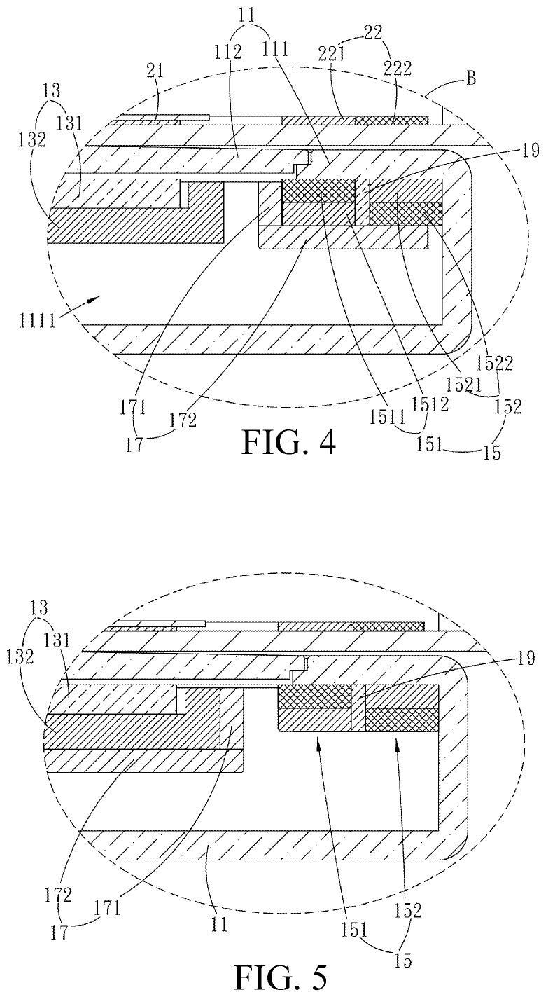

Refer to FIG. 1 to FIG. 4. FIG. 1 is the perspective view of the wireless charger of the present disclosure. FIG. 2 is the sectional view alsing A-A′ line of FIG. 1. FIG. 3 is an exploded view of the wireless charger of the present disclosure. FIG. 4 is an enlarged view of the B region of the first embodiment of FIG. 2. As shown in the figures, the present disclosure provides a wireless charger 1 comprising a housing 11, a wireless charging assembly 13 and a positioning magnet assembly 15. The wireless charging assembly 13 is arranged in the housing 11. The positioning magnet assembly 15 is arranged around the wireless charging assembly 13. The spacer assembly 17 is arranged between the wireless charging assembly 13 and the magnet positioning assembly 15. In this way, the spacer assembly 17 separates the wireless charging assembly 13 and the positioning magnet assembly 15, wherein the material of the spacer assembly 17 is iron.

Refer to FIG. 2 and FIG. 3. In this embodiment, the housing 11 comprises a case 111 and a cover plate 112. The case 111 comprises an accommodating slot 1111. The cover plate 112 covers the notch of the accommodating slot 1111. The wireless charging assembly 13, the positioning magnet assembly 15 and the spacer assembly 17 are arranged in the accommodating slot 1111. The wireless charging assembly 13 is arranged at the position of the cover plate 112 correspondingly. the positioning magnet assembly15 is arranged around the notch of the accommodating slot 1111. The spacer assembly 17 comprises a side plate 171 and a bottom plate 172. The bottom plate 172 is disposed at the bottom of the positioning magnet assembly 15. The side plate 171 is disposed at one side of the bottom plate 172 close to the wireless charging assembly 15. In this embodiment, the height of the side plate 171 is equal to or higher than one third of the height of the side surface of the positioning magnet assembly 15 adjacent to the wireless charging assembly 13. The height of the side panel 171 can be adjusted according to users' needs.

The wireless charging assembly 13 of the embodiment comprises a transmitting coil 131 and a magnetically conductive carrier plate 132. The transmitting coil 131 is arranged on the magnetically conductive carrier plate 132. The transmitting coil 131 corresponds to the surface of the housing 11. The magnetically conductive carrier plate 132 helps to concentrate the magnetic field lines of the transmitting coil 131, so as to improve the charging efficiency of the wireless charging assembly 13. However, the positioning magnet assembly 15 for positioning the electronic device 2 has a magnetic force, and the magnetic force of the positioning magnet assembly 15 would affect the magnetism of the magnetically conductive carrier plate 132 of the wireless charging assembly 13. In this embodiment, the wireless charging assembly 13 and the positioning magnet assembly 15 are separated by the spacer assembly 17. The spacer assembly 17 can effectively reduce the magnetic force of the positioning magnet assembly 15 from escaping toward the magnetic conductive carrier plate 132 of the wireless charging assembly 13. In this way, the magnetic field interference of the positioning magnet assembly 15 to the wireless charging assembly 13 can be effectively avoided, and the charging effect of the wireless charging assembly 13 can be prevented from being affected. This embodiment can reduce the interference of the magnetic force of the positioning magnet assembly 15 on the charging process of the wireless charging assembly 13 by using the spacer assembly 17, so as to provide a good charging effect.

Refer to FIG. 3. The positioning magnet assembly 15 includes a first positioning magnet 151 and a second positioning magnet 152. The second positioning magnet 152 is located on one side of the first positioning magnet 151. The first positioning magnet 151 is adjacent to the wireless charging assembly 13. The second positioning magnet 152 is away from the wireless charging assembly 13. The first positioning magnet 151 and the second positioning magnet 152 are fixed by the glue 19. Further, two sides of the first positioning magnet 151 include a first magnetic pole 1511 and a second magnetic pole 1512 respectively. The first magnetic pole 1511 faces the surface of the housing 11. The second magnetic pole 1512 faces the interior of the housing 11. Two sides of the second positioning magnet 152 respectively include a third magnetic pole 1521 and a fourth magnetic pole 1522. The third magnetic pole 1521 faces the surface of the housing 11 and the fourth magnetic pole 1522 faces the interior of the housing 11. The magnetic pole of the first magnetic pole 1511 and the magnetic pole of the second magnetic pole 1512 is different; the magnetic pole of the third magnetic pole 1521 and the magnetic pole of the fourth magnetic pole 1522 is different; the magnetic pole of the first magnetic pole 1511 and the magnetic pole of the fourth magnetic pole 1522 is the same; the magnetic pole of the second magnetic pole 1512 and the magnetic pole of the third magnetic pole 1521 is the same.

In this embodiment, the surfaces of the wireless charging assembly 13 and the positioning magnet assembly 15 corresponding to the surface of the housing 11 are used to place the electronic device 2 for charging. The electronic device 2 includes a device receiving coil 21 and a device positioning magnet 22. The device positioning magnet 22 is located around the device receiving coil 21. The device receiving coil 21 corresponds to the transmitting coil 131 of the wireless charging assembly 13. The device positioning magnet 22 corresponds to the positioning magnet assembly 15. The device positioning magnet 22 includes a first device positioning magnetic pole 221 and a second device positioning magnetic pole 222. The first device positioning magnetic pole 221 is located inside the second device positioning magnetic pole 222. The first device positioning magnetic pole 221 corresponds to the first magnetic pole 1511. The second device positioning magnetic pole 222 corresponds to the third magnetic pole 1521. In this embodiment, the first magnetic pole 1511 and the fourth magnetic pole 1522 are S poles, and the second magnetic pole 1512 and the third magnetic pole 1521 are N poles. The first device positioning magnetic pole 221 corresponding to the first magnetic pole 1511 is an N pole, and the second device positioning magnetic pole 222 corresponding to the third magnetic pole 1521 is an S pole.

In addition, this embodiment does not limit the number or arrangement of the positioning magnet assembly 15. When the positioning magnet assembly 15 is single, the positioning magnet assembly 15 is a ring magnet, and the wireless charging assembly 13 is disposed at the center of the positioning magnet assembly 15. When there are multiple positioning magnet assemblies 15, the multiple positioning magnet assemblies 15 are arranged around the wireless charging assembly 13. The positioning magnet assembly 15 can be configured according to users' needs or the adjustment of the device configuration. This embodiment does not limit the implementation style of the positioning magnet assembly 15.

FIG. 5 is an enlarged view of the second embodiment. As shown in the figure, the drawing of this embodiment uses the area specified in FIG. 3 as the comparison area for the differences between the various embodiments, and other components of this embodiment are the same as those of the first embodiment. The difference between the present embodiment and the first embodiment lies in the arrangement of the spacer assembly 17. In this embodiment, the spacer assembly 17 includes a side plate 171 and a bottom plate 172. The bottom plate 172 is disposed at the bottom of the wireless charging assembly 13. The side plate 171 is disposed on the side of the bottom plate 172 close to the positioning magnet assembly 15. The height of the side plate 171 is equal to or higher than one third of the height of the side of the wireless charging assembly 13 adjacent to the positioning magnet assembly 15.

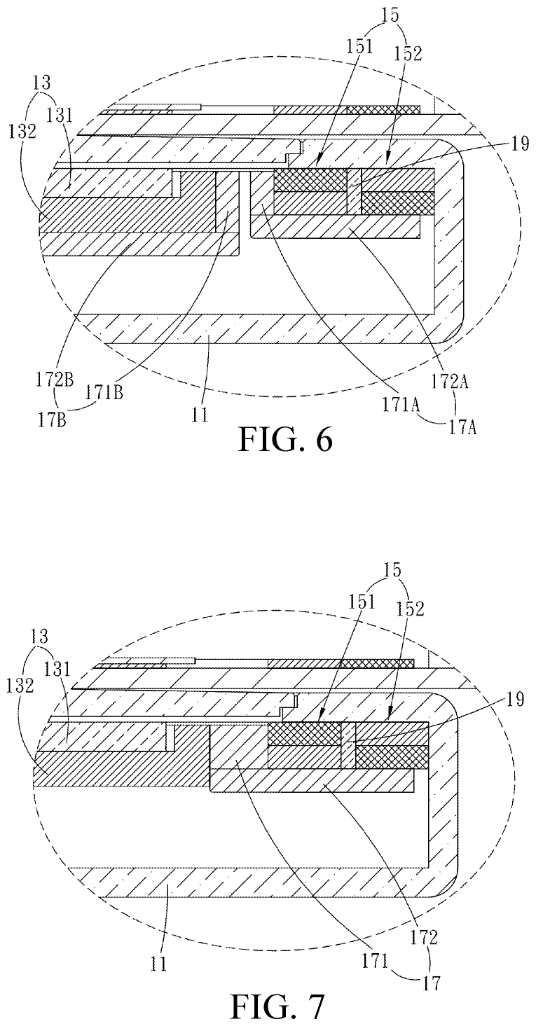

FIG. 6 is an enlarged view of the third embodiment. As shown in the figure, this embodiment is the same as the drawing of the second embodiment. The difference between this embodiment and the first embodiment lies in the number of spacer assembly 17. In this embodiment, the spacer assembly 17 includes a first spacer 17A and a second spacer 17B. The first spacer 17A and the second spacer 17B are located between the wireless charging assembly 13 and the positioning magnet assembly 15. The first spacer 17A is disposed on the positioning magnet assembly 15. The second spacer 17B is disposed on the wireless charging assembly 13. The first spacer 17A includes a first side plate 171A and a first bottom plate 172A. The first bottom plate 172A is disposed at the bottom of the positioning magnet assembly 15. The first side plate 171A is disposed on the side of the first bottom plate 172A close to the wireless charging assembly 13. The second spacer 17B includes a second side plate 171B and a second bottom plate 172B. The second bottom plate 172B is disposed at the bottom of the wireless charging assembly 13. The second side plate 171B is disposed on the side of the second bottom plate 172B close to the positioning magnet assembly 15. In this way, the spacer assembly 17 may separate the wireless charging element 13 and the positioning magnet element 15 better.

FIG. 7 is an enlarged view of the fourth embodiment. As shown in the figure, this embodiment is the same as the drawing of the second embodiment. The difference between this embodiment and the first embodiment lies in the structure of spacer assembly 17. In this embodiment, the spacer assembly 17 includes a side plate 171 and a bottom plate 172. The bottom plate 172 is disposed at the bottom of the positioning magnet assembly 15. The side plate 171 is disposed on the side of the bottom plate 172 close to the wireless charging assembly 15 The thickness of the side plate 171 fills the space between the wireless charging assembly 13 and the positioning magnet assembly 15. In other words, this embodiment isolates the influence of the magnetic force of the positioning magnet assembly 15 toward the wireless charging assembly 13 by thickening the side plate 171. In addition, in this embodiment, the wireless charging assembly 13 and the positioning magnet assembly 15 can also be disposed on both sides of the side plate 171 to enhance the overall strength of the structure.

In summary, the disclosure provides a wireless charge, in which the wireless charging assembly and the positioning magnet assembly are separated by the spacer assembly. The spacer assembly can effectively reduce the magnetic force of the positioning magnet assembly to escape toward the magnetically conductive carrier plate of the wireless charging assembly. In this way, the magnetic field interference of the positioning magnet assembly on the wireless charging assembly can be effectively avoided, so as to provide a good charging effect.

It is to be understood that the term “comprises”, “comprising”, or any other variants thereof, is intended to encompass anon-exclusive inclusion, such that a process, method, article, or device of a series of elements not only comprise those elements but further comprises other elements that are not explicitly listed, or elements that are inherent to such a process, method, article, or device. An element defined by the phrase “comprising a . . . ” does not exclude the presence of the same element in the process, method, article, or device that comprises the element.

Although the present disclosure has been explained in relation to its preferred embodiment, it does not intend to limit the present disclosure. It will be apparent to those skilled in the art having regard to this present disclosure that other modifications of the exemplary embodiments beyond those embodiments specifically described here may be made without departing from the spirit of the disclosure. Accordingly, such modifications are considered within the scope of the disclosure as limited solely by the appended claims.

What is claimed is:

1. A wireless charger, comprising:
a housing;
a wireless charging assembly, arranged in the housing;
a positioning magnet assembly arranged around the wireless charging assembly; and
a spacer assembly arranged between the wireless charging assembly and the magnet positioning assembly.

2. The wireless charger according to claim 1, wherein the spacer assembly comprises a side plate and a bottom plate; the bottom plate is disposed at the bottom of the positioning magnet assembly; the side plate is disposed at one side of the bottom plate close to the wireless charging assembly.

3. The wireless charger according to claim 2, wherein the height of the side plate is equal to or higher than one third of the height of the side surface of the positioning magnet assembly adjacent to the wireless charging assembly.

4. The wireless charger according to claim 1, wherein the spacer assembly comprises a side plate and a bottom plate; the bottom plate is disposed on the bottom of the wireless charging assembly, and the side plate is disposed on a side of the bottom plate close to the positioning magnet assembly.

5. The wireless charger according to claim 4, wherein the height of the side plate is equal to or higher than one third of the height of the side surface of the wireless charging assembly adjacent to the positioning magnet assembly.

6. The wireless charger according to claim 1, wherein the spacer assembly comprises a first spacer and a second spacer; the first spacer and the second spacer are located between the wireless charging assembly and the positioning magnet assembly; the first spacer is disposed in the positioning magnet assembly; the second spacer is disposed in the wireless charging assembly.

7. The wireless charger according to claim 6, wherein the first spacer comprises a first side plate and a first bottom plate; the first bottom plate is disposed at the bottom of the positioning magnet assembly; the first side plate is disposed at one side of the first bottom plate close to the wireless charging assembly; the second spacer comprises a second side plate and a second bottom plate; the second bottom plate is disposed at the bottom of the wireless charging assembly; the second side plate is disposed at one side of the second bottom plate close to the positioning magnet assembly.

8. The wireless charger according to claim 1, wherein the material of the spacer assembly is iron.

9. The wireless charger according to claim 1, wherein the positioning magnet assembly comprises a first positioning magnet and a second positioning magnet; the second positioning magnet is located at one side of the first positioning magnet; the first positioning magnet is adjacent to the wireless charging assembly; and the first positioning magnet is adjacent to the wireless charging assembly; the second positioning magnet is away from the wireless charging assembly; the first positioning magnet and the second positioning magnet are fixed by glue.

10. The wireless charger according to claim 1, wherein two sides of the first positioning magnet respectively comprise a first magnetic pole and a second magnetic pole; the first magnetic pole faces the surface of the housing; the second magnetic pole faces the interior of the housing; two sides of the second positioning magnet respectively comprise a third magnetic pole and a fourth magnetic pole; the third magnetic pole faces the surface of the housing; the fourth magnetic pole faces the interior of the housing.

11. The wireless charger according to claim 10, wherein the magnetic pole of the first magnetic pole and the magnetic pole of the second magnetic pole is different; the magnetic pole of the third magnetic pole and the magnetic pole of the fourth magnetic pole is different; the magnetic pole of the first magnetic pole and the magnetic pole of the fourth magnetic pole is the same; the magnetic pole of the second magnetic pole and the magnetic pole of the third magnetic pole is the same.

12. The wireless charger according to claim 1, wherein there are multiple positioning magnet assemblies, and the multiple positioning magnet assemblies are arranged around the wireless charging assembly.

13. The wireless charger according to claim 1, wherein the wireless charging assembly comprises a transmitting coil and a magnetically conductive carrier plate; the transmitting coil is arranged on the magnetically conductive carrier plate; the transmitting coil corresponds to the surface of the housing.

14. The wireless charger according to claim 13, wherein the wireless charging assembly and the positioning magnet assembly correspond to the surface of the housing for placing the electronic device for charging; the electronic device comprises a device receiving coil and a device positioning magnet; the device positioning magnet is located around the device receiving coil; the device receiving coil corresponds to the transmitting coil of the wireless charging assembly; the device positioning magnet corresponds to the positioning magnet assembly.

15. The wireless charger according to claim 1, wherein the housing comprises a case and a cover plate; the case comprises an accommodating slot; the cover plate covers the notch of the accommodating slot, the wireless charging assembly; the wireless charging assembly, the positioning magnet assembly and the spacer assembly are arranged in the accommodating slot; the wireless charging assembly is arranged at the position of the cover plate correspondingly; the positioning magnet assembly is arranged around the notch of the accommodating slot.
